(19) United States
(12) Patent Application Publication
(10) Pub. No.: US 2022/0244195 A1
(43) Pub. Date: Aug. 4, 2022

(54) METHOD AND APPARATUS FOR DETECTING ICE FORMATION ON A SURFACE USING RESONANT SENSORS

(71) Applicant: THE UNIVERSITY OF BRITISH COLUMBIA, Vancouver (CA)

(72) Inventors: Kevin Golovin, Kelowna (CA); Mohammad Zarifi, Kelowna (CA); Benjamin Wiltshire, Kelowna (CA); Kiana Mirshahidi, Kelowna (CA); Ryan Kozak, Vancouver (CA)

(73) Assignee: THE UNIVERSITY OF BRITISH COLUMBIA, Vancouver, BC (CA)

(21) Appl. No.: 17/629,561

(22) PCT Filed: Jul. 23, 2020
(86) PCT No.: PCT/CA2020/051015

§ 371 Date: Jan. 24, 2022

Related U.S. Application Data
(60) Provisional application No. 62/877,399, filed on Jul. 23, 2019.

(51) Int. Cl. G01N 22/04; B64D 15/20

(52) U.S. Cl. CPC G01N 22/04; B64D 15/20

(57) ABSTRACT

Disclosed is system and method for detecting formation of solid-state water on a surface of a body. The system comprises at least one microwave resonator sensor locatable on the body under the surface and an analyzer operably coupled to the at least one passive microwave resonator; the analyzer configured to measure at least one parameter of the response of the at least one microwave resonator sensor. The at least one parameter varies in relation to at least one of the permittivity and conductivity of the region above the surface calibrated to output a signal indicating and the analyzer is configured to output an indication when the at least one parameter indicates that solid-state water has formed on the surface. The method comprises measuring the at least one parameter at the analyzer and outputting a signal indicating the formation of solid-state water on the surface.

### BACKGROUND

### 1. Technical Field

This disclosure relates generally to ice detection and in particular to a method and apparatus for detecting ice formation on a surface using resonant sensors.

### 2. Description of Related Art

Ice and frost formation presents a hazard to many activities and means of transportation. In particular, ice and frost formation on airplane surfaces, such as wings poses a significant risk to the safety of the airplane due to disrupting airflow over the wings. Similarly, ice and frost accumulation on roadways and other driving surfaces is a well-known cause of accidents.

Numerous preventative and removal measures are commonly utilized to reduce the risks associated with ice and frost accumulation including, the application of heat or ice melting liquids, gels and salts. One difficulty in determining when such preventative or ice removal measures are required is to accurately determine when ice or frost has formed. In particular, users may frequently attempt to visually determine when frost or ice has formed. However it will be appreciated that some forms of ice may appear similar to the underlying surface making such visual detection difficult. Furthermore, some frost or ice may be too thin to visually observe with the human eye while still having an adverse effect on the surface properties including coefficient of friction of the surface.

Although conditions for ice formation can be predicted based on temperature and other atmospheric conditions, such methods only predict when ice or frost formation is possible and not when it has actually occurred. In addition, it will be appreciated that ice and frost may form at temperatures above the freezing point of water for a given set of atmospheric conditions due to the effects of thermal radiation.

Due to the difficulties of determining when ice or frost has formed, many preventative measures will apply heat or an ice melting compositions to melt or prevent the formation of frost or ice at temperatures above those predicted as set out above. However, it will be appreciated that such us of the energy or compositions is wasteful and inefficient where they are used in conditions where ice or frost has not actually formed.

### SUMMARY OF THE DISCLOSURE

According to a first embodiment, there is disclosed a system for detecting formation of solid-state water on a surface of a body comprising at least one microwave resonator sensor locatable on the body under the surface and an analyzer operably coupled to the at least one passive microwave resonator; the analyzer configured to measure at least one parameter of the response of the at least one microwave resonator sensor. The at least one parameter varies in relation to at least one of the permittivity and conductivity of the region above the surface calibrated to output a signal indicating and the analyzer is configured to output an indication when the at least one parameter indicates that solid-state water has formed on the surface.

The at least one microwave resonator sensor may comprise a plurality of microwave resonator sensors. The plurality of microwave resonator sensors may be arranged in an array on the surface of the body. The at least one microwave resonator sensor may be formed on a substrate. The substrate may be flexible.

The at least on parameter may be selected from the group consisting of resonant frequency, resonant amplitude and quality factor. A change in the at least one parameter may indicate the formation of solid-state water on the surface.

The system may further comprise a layer of a cover material applied over the at least one microwave resonator sensor. The cover material may be selected to have a known permittivity. The cover material may applied over the surface of the body. The cover material may comprise paint. The cover material may be superhydrophobic.

The system may further comprise a heating element activated in response to analyzer indicating the formation of solid-state water on the surface. The heating element may be located under the microwave resonator sensor.

According to a further embodiment, there is disclosed a method for sensing formation of solid-state water on a surface of a body comprising positioning a passive microwave resonator sensor on the body under the surface and measuring, in real time, at least one parameter of the response of the passive microwave resonator sensor at an analyzer operably connected to the passive microwave resonator sensor. The method further comprises outputting a signal indicating the formation of solid-state water on the surface in response to a change in the at least one parameter of the response of the passive microwave resonator sensor.

The at least on parameter may be selected from the group consisting of resonant frequency, resonant amplitude and quality factor. A change in the at least one parameter may indicate the formation of solid-state water on the surface. The method may further comprise activating a heating element located under the at least one microwave resonator sensor in response to the signal indicating the formation of solid-state water on the surface.

The at least one microwave resonator sensor may comprise a plurality of microwave resonator sensors. The plurality of microwave resonator sensors may be arranged in an array on the surface of the body. The at least one microwave resonator sensor may be formed on a substrate. The substrate may be flexible.

According to a further embodiment, there is disclosed a method for monitoring the state of mater above a surface comprising positioning a passive microwave resonator sensor on a body under the surface thereof, measuring, in real time, at least one parameter of the response of the passive microwave resonator sensor at an analyzer operably connected to the passive microwave resonator sensor and determining, utilizing the analyzer when a change in at least one of the permittivity and conductivity of the region above the surface, based on the at least one parameter has occurred indicating a change in state of region above the surface.

The at least on parameter may be selected from the group consisting of resonant frequency, resonant amplitude and quality factor. The analyzer may be calibrated to at least one of the permittivity and conductivity of water in ach of gas, liquid and solid states. The analyzer may be configured to output a signal indicating the formation of a solid-state water above the surface. The method may further comprise determining, utilizing the analyzer, if the state of the material above the surface has changed from a liquid to a solid indicating the formation of ice on the surface or if the state of the material above the surface has changed from a gas to a solid indicating the formation of frost on the surface.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a perspective view of an exemplary embodiment of a microwave resonator sensor applied to a surface for detecting the formation of solid-state water thereon.

FIG. 2 is a plan view of the microwave resonator sensor of FIG. 1 according an exemplary embodiment.

FIG. 3 is a cross section of the microwave resonator sensor of FIG. 1 according to an exemplary embodiment.

FIG. 4A is a graph illustrating ice formation and melting at different stages on a microwave resonator sensor plotted with S21 parameters versus frequency for different states of freezing and melting.

FIG. 4B is a graph illustrating resonant amplitude versus time for frost freezing on a microwave resonator sensor.

FIG. 4C is a graph illustrating resonant frequency versus time for frost freezing on a microwave resonator sensor.

FIG. 4D is a graph illustrating quality factor versus time for frost freezing on a microwave resonator sensor.

FIG. 5A is a graph illustrating the measured S21 resonance profile of the microwave resonator sensor of FIG. 1 profiles during a freezing sequence for a drop of water.

FIG. 5B is a graph illustrating the measured S21 resonance profile of the microwave resonator sensor of FIG. 1 profiles during a thawing sequence.

FIG. 5C is a graph illustrating resonant amplitude and temperature versus time for a drop of water freezing on a microwave resonator sensor.

FIG. 5D is a graph illustrating quality factor time and temperature versus time for a drop of water freezing on a microwave resonator sensor.

FIG. 6A is a plan view illustration of a microwave resonator sensor according to an exemplary embodiment.

FIG. 6B is a plan view illustration of a microwave resonator sensor according to a further exemplary embodiment.

FIG. 6C is a plan view illustration of a microwave resonator sensor according to a further exemplary embodiment.

FIG. 6D is a plan view illustration of a microwave resonator sensor according to a further exemplary embodiment formed on a flexible substrate.

FIG. 7A is a graph illustrating the measured S21 resonance profile of the microwave resonator sensor of FIG. 6A with water, ice and no substance located thereon.

FIG. 7B is a graph illustrating the measured S21 resonance profile of the microwave resonator sensor of FIG. 6B with water, ice and no substance located thereon.

FIG. 7C is a graph illustrating the measured S21 resonance profile of the microwave resonator sensor of FIG. 6C located on rigid substrate with water, ice and no substance located thereon.

FIG. 7D is a graph illustrating the measured S21 resonance profile of the microwave resonator sensor of FIG. 6C located on a flexible substrate with water, ice and no substance located thereon.

FIG. 8A is a graph illustrating the measured S21 resonance profile of the microwave resonator sensor of FIG. 6A at different stages while a drop of water is frozen thereon.

FIG. 8B is a graph illustrating the measured S21 resonance profile of the microwave resonator sensor of FIG. 6B at different stages while a drop of water is frozen thereon.

FIG. 8C is a graph illustrating the measured S21 resonance profile of the microwave resonator sensor of FIG. 6C as located on a rigid substrate at different stages while a drop of water is frozen thereon.

FIG. 8D is a graph illustrating the measured S21 resonance profile of the microwave resonator sensor of FIG. 6C as located on a flexible substrate at different stages while a drop of water is frozen thereon.

FIG. 9A is a graph illustrating the S21 resonance amplitude and temperature versus time during a freezing and thawing sequence of a drop of water on the microwave resonator sensor of FIG. 6A.

FIG. 9B is a graph illustrating the S21 resonance amplitude and temperature versus time during a freezing and thawing sequence of a drop of water on the microwave resonator sensor of FIG. 6B.

FIG. 9C is a graph illustrating the S21 resonance amplitude and temperature versus time during a freezing and thawing sequence of a drop of water on the microwave resonator sensor of FIG. 6C on a rigid substrate.

FIG. 9D is a graph illustrating the S21 resonance amplitude and temperature versus time during a freezing and thawing sequence of a drop of water on the microwave resonator sensor of FIG. 6C on a rigid substrate.

FIG. 10 is a plan view illustration of a microwave resonator sensor according to a further exemplary embodiment.

FIG. 11 is a plan view illustration of the rear surface of ground plate of the microwave resonator sensor of FIG. 10 with a resistive heater patterned thereon.

FIG. 12 is a graph illustrating the S21 resonance amplitude versus time during heated and unheated melting sequences of a drop of water on the microwave resonator sensor of FIG. 10.

FIG. 13 is a block diagram of a system for detecting the formation of solid-state water on a surface according to an exemplary embodiment.

FIG. 14 is a graph illustrating the measured S21 resonance profile of the treated and untreated microwave resonator sensor of FIG. 10 at 12 degrees Celsius and −12 degrees Celsius.

FIG. 15 is a graph illustrating the S21 resonance amplitude and temperature versus time during a freezing sequence of a drop of water on the untreated and untreated microwave resonator sensor of FIG. 10.

FIG. 16 is a graph illustrating the S21 resonance amplitude and temperature versus time during a frost formation sequence on the untreated and untreated microwave resonator sensor of FIG. 10.

FIG. 17A is a perspective side view of a droplet of water on the untreated surface of the microwave resonator of FIG. 10.

FIG. 17B is a perspective side view of a droplet of water on the treated surface of the microwave resonator of FIG. 10.

### DETAILED DESCRIPTION

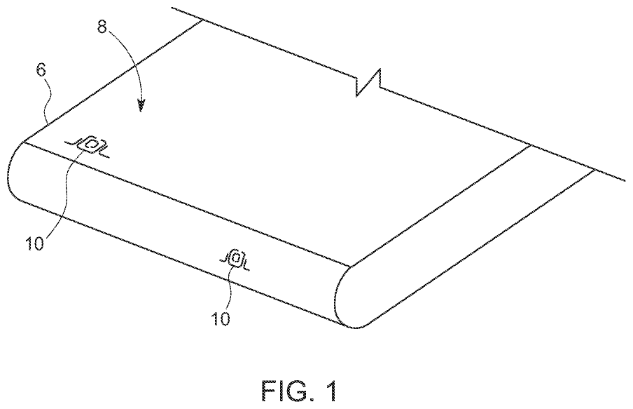

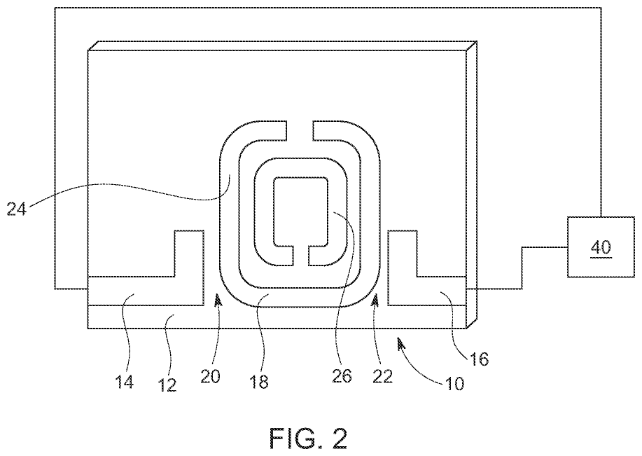

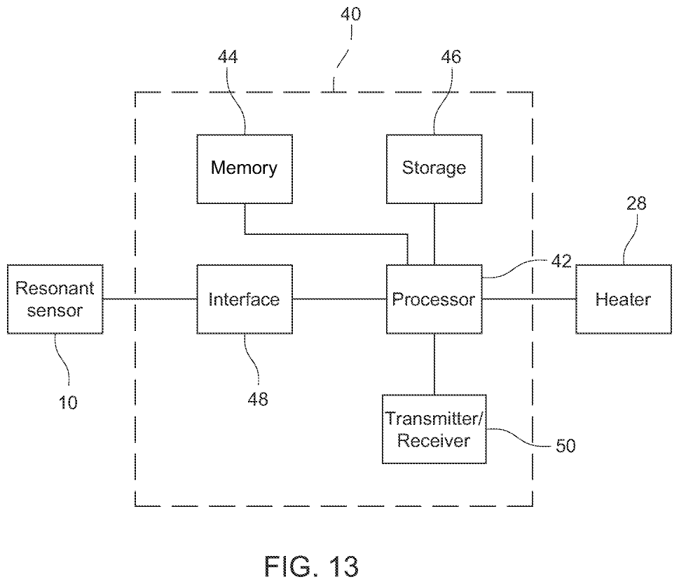

Aspects of the present disclosure are now described with reference to exemplary apparatuses, methods and systems. Referring to FIG. 1, an exemplary apparatus for detecting the formation of solid-state water according to an exemplary embodiment is shown generally at. As utilized herein, ice and frost are used interchangeably to denote a solid state of water in any physical structure. The apparatus comprises microwave resonator sensor 10 applied to a surface 8 of a body 6. The microwave resonator sensor 10 is operable connected to an analyzer 40 (shown in FIGS. 2 and 13) operable to measure at least one of the parameters of the response of the microwave resonator sensor for changes therein indicating a change of phase to or formation of solid-state water on the surface 8.

Turning now to FIG. 2, a plan view of an exemplary microwave resonator is illustrated. The microwave resonator 10 comprises a planar split ring type resonator, although it will be appreciated that other microwave resonators may be utilized as well. As illustrate in FIG. 2, the microwave resonator may be located on a substrate 12 and may include first and second feed lines, 14 and 16, respectively with a resonator loop 18 therebetween. The first and second feed lines 14 and 16 may be operably connected to the analyzer 40 as illustrated and may be utilized to input a signal to generate a resonant frequency of the resonator and obtain an output therefrom according to known principles and methods. The resonator loop 18 may be separated from the first and second feed lines 14 and 16 by a coupling gap, 20 and 22, respectively as are commonly known. In particular the resonator loop 18 of the exemplary embodiment of FIG. 2 includes first and second concentric rings, 24 and 26, respectively, having a split or gap therein as are commonly known. Although a particular microwave resonator 10 is illustrated in FIG. 2, it will be appreciated that other microwave resonators may also be utilized including, without limitation, a loop-type, line-type, meander-type, and triangular-type or combinations thereof.

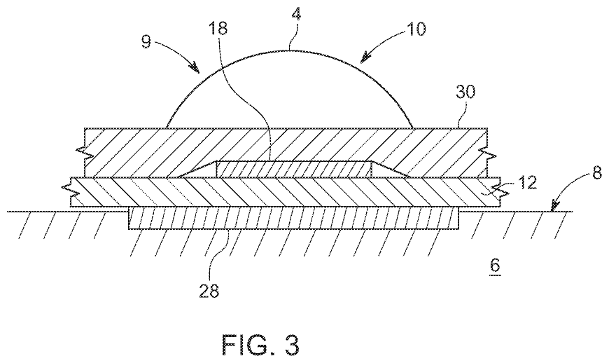

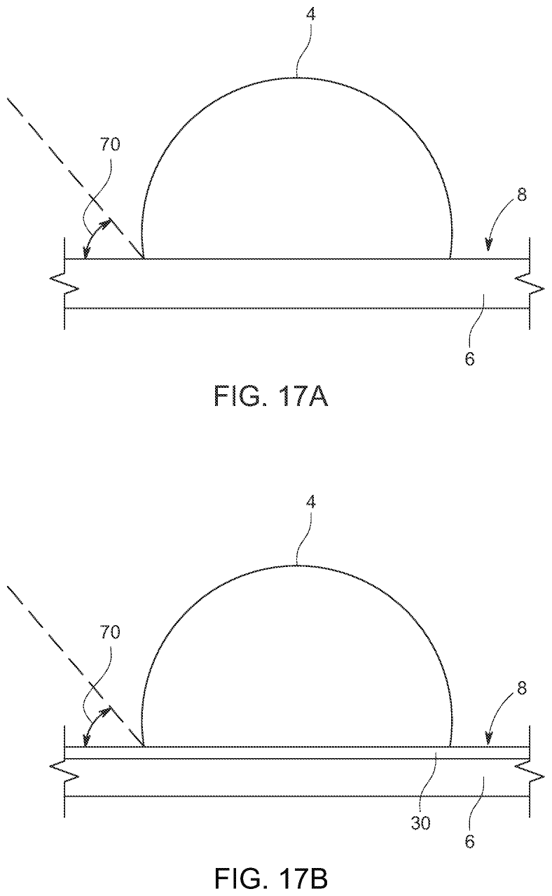

Turning now to FIG. 3, a cross sectional view of the microwave resonator 10 and body 6 is illustrated. As illustrated and set out above, the microwave resonator 10 may be located on a substrate 12 which is located on or within the surface 8 of the body. It will be appreciated that the surface 8 of the body may be utilized as the substrate for the microwave resonator 10 as well. Optionally, the microwave resonator 10 may be formed in the surface or any other layer of the body 6, such by way of non-limiting example, an airplane component or roadway or other driving surface. In particular, the microwave resonator 10 will be located below the surface 8 of such finished article, wherein formation of ice and frost is anticipated to occur on such surface 8. The microwave resonator 10 may optionally include a heating element 28 thereunder for providing heat to the resonator to prevent or remove ice from the surface thereof. Optionally, the heating element 28 may be located in any other location including proximate to or distally from the microwave resonator 10. The microwave resonator 10 may be provided with a layer of a covering material 30. The covering material 30 may be any commonly utilized or required material intended to cover the body 6 such as paints and other decorative coatings as well as superhydrophobic materials to prevent the adhesion of water drops 4 or the like. In particular, it is known that superhydrophobic coatings reduce the interfacial surface area between a drop of liquid and the surface of the coating by increasing the contact angle, generally indicated at 70 in FIGS. 17A and 17B for an uncoated and coated surface. The superhydrophobic material may be any known hydrophobic or superhydrophobic material as are known including any polymeric or ceramic material that is applied in solid, liquid or gel state. It will be appreciated that the superhydrophobic material should be selected to be non-conductive so as to not interfere with the operation of the microwave resonator and applied in a layer thin enough to permit the selected microwave resonator to measure the state of mater above the surface thereof.

In operation, at least one microwave resonator 10 is applied to or within a body 6 and connected to the analyzer 40. The analyzer 40 is illustrated in FIG. 13 and may comprise any processor or other computing device for performing the required analysis of the output parameters of the microwave resonator. It will be appreciated that the analyzer 40 may be any commonly known processing device, such as, by way of non-limiting example, a tablet, laptop computer, smartphone, PDA, ultra-mobile PC (UMPC), desktop computer, server etc. operable to perform the functions and calculations required herein. It will be understood that the architecture herein is provided for example purposes only and does not limit the scope of the various implementations of the present systems and methods.

In particular, with reference to FIG. 13, the analyzer 40 may include a processor 42, memory 44 that stores machine instructions that when executed by the processor 42, cause the processor 42 to perform one or more of the operations and methods required herein a storage 46 for recording or storing data representing the measured parameters of the microwave resonator. As illustrated in FIG. 13, the microwave resonator 10 may be operably connected to the processor 42 through an interface 48 operable to receive the signals outputted by the microwave resonator. In particular, the interface 48 may comprise a separate interface for each microwave resonator 10 or may optionally comprise a bus, as is commonly known for operably contending more than one microwave resonator thereto. The interface 48 may communicate with the microwave resonator 10 through any known means including wired and wireless protocols, both analogue and digital.

More generally, in this specification, including the claims, the term “processor” is intended to broadly encompass any type of device or combination of devices capable of performing the functions described herein, including (without limitation) other types of microprocessing circuits, microcontrollers, other integrated circuits, other types of circuits or combinations of circuits, logic gates or gate arrays, or programmable devices of any sort, for example, either alone or in combination with other such devices located at the same location or remotely from each other. Additional types of processor(s) will be apparent to those ordinarily skilled in the art upon review of this specification, and substitution of any such other types of processor is considered not to depart from the scope of the present invention as defined by the claims appended hereto. In various embodiments, the processor 42 can be implemented as a single-chip, multiple chips and/or other electrical components including one or more integrated circuits and printed circuit boards.

Computer code comprising instructions for the processing circuit(s) to carry out the various embodiments, aspects, features, etc. of the present disclosure may reside in the memory 44. The processor 42 together with a suitable operating system may operate to execute instructions in the form of computer code and produce and use data. By way of example and not by way of limitation, the operating system may be Windows-based, Mac-based, or UNIX or Linux-based, among other suitable operating systems. Operating systems are generally well known and will not be described in further detail here.

Memory 44 may include various tangible, non-transitory computer-readable media including Read-Only Memory (ROM) and/or Random-Access Memory (RAM) including dynamic random-access memory (DRAM), static access memory (SRAM) synchronous DRAM (SDRAM) or combinations thereof. In particular, in some embodiments, the memory 44 may include ROM for use at boot up and RAM for program and data storage while executing programs to implement the present system and methods. More generally, the term “memory” as used herein encompasses one or more storage mediums and generally provides a place to store computer code (e.g., software and/or firmware) and data that are used by the analyzer 40. It may comprise, for example, electronic, optical, magnetic, solid-state or any other storage or transmission device including any type of memory capable of performing the functions thereof.

The storage 46 may comprise any type of data storage device as are commonly known including, without limitation, magnetic drives, optical drives, solid state drives, hard disk drives or the like or online or remote storage such, for example, in “the cloud”. The processor 42 may send and receive information to and from the storage 46 and memory 44 by any known means including wired, wireless or over a network. The analyzer 40 may further include a transmitter/receiver 50 operable to transmit information and data received at, recorded or processed at the processor 42. The transmitter/receiver 50 may communicate with a remote device, including a server, remote computer terminal or other processing or display equipment.

The remote equipment may be operable to provide an alarm or warning to a user that solid state water has formed on the surface 8 or activate a heater, or alternatively as illustrated in FIG. 13, the processor may directly activate the heater 28 in response to detecting the presence of solid state water on the surface 8.

Although general criteria for the analyzer 40 are set out above, it will be appreciated that purpose built analyzers may also be utilized. In particular, purpose built analyzers including a FieldFox Microwave Analyzer from Keysight®, by way of non-limiting example may be utilized.

As previously mentioned, the microwave resonator 10 may be used detect the state of matter occupying the region on the surface 8 and within a measured region 9 above the microwave resonator 10, such as the water drop 4 illustrated in FIG. 3. In particular, the microwave resonator 10 may be used to determine if such a region is occupied by air, liquid water or solid-state water. It is known that the permittivity and conductivity of materials changes depending on the state of matter of that material. In particular, it is known that water has a relative permittivity E=80-90 depending on temperature whereas ice has a relative permittivity of just E=3.2 and air has a permittivity of E=1.

Microwave resonators as set out herein propagate a concentrated electric field at a specific resonant frequency which can interact with the local environment. The dielectric properties of the environment are closely tied to a combination of the resonant frequency, resonant amplitude, and quality factor of the measured scattering parameter. Accordingly, the effective permittivity experienced the microwave resonator 10 is altered in response to a change in state of such mater within the measured region 9. This change in effective permittivity experienced by the microwave resonator 10 permits measuring and comparing of the parameters of the microwave resonator, including resonant frequency, resonant amplitude and quality factor of the measured scattering parameter to identify, classify, or monitor the local environment the state of mater in the measured region 9.

In particular, the microwave resonator 10 may be selected and designed to have a resonant frequency and quality factor for the material to be monitored. In the present example, for use with monitoring the state of mater of water, the microwave resonator was selected to have a resonant frequency between about 3.5-5.0 GHz, with resonant amplitude −14.5 dB and quality factor of 250, although it will be appreciated that other design parameters may be utilized as well Advantageously, the interaction between the signal wave and the nearby material enables non-contact extraction of electronic signal information. It will be appreciated that the present methods and systems also permit real-time monitoring of the state of the mater in the measured region 9 and permit determining when the change in state of the mater actually begins and ends independent of the conditions which may give rise to such changes in state.

Furthermore, the microwave resonator 10 may also be utilized to detect the presence of water on the surface 8 by similarly measuring the change in the parameters as set out above. In particular, the microwave resonator 10 may be selected and configured to detect the melting of ice or frost to water or may optionally be selected or configured to detect the presence of a de-icing fluids and/or water mixtures when utilized on airplanes or the like. Additionally, the analyzer 40 may be configured and programmed to determine if the solid state of water is ice or frost due to the parameters measured in the state before the formation of solid state water. In particular, it will be appreciated that once solid state water has formed, the analyzer may then look up the parameters before such formation to determine if the microwave resonator was detecting the presence of liquid water (having a permittivity of approximately E=1) in which case the analyzer can indicate that the solid state of water is ice or air (having a permittivity of approximately E=3.2) in which case the analyzer can indicate that the solid state of water is frost. Such distinction may be useful in selection of the type and quantity of de-icing steps performed to remove such ice or frost.

### Experiment 1

A first experiment involved measuring the S21 parameters were measured for the microwave resonator illustrated in FIG. 2 during freezing and thawing sequences. The sensor structure was fabricated on a high-frequency RT/duroid 5880 substrate from Rogers, with a dielectric thickness of 0.79 mm and copper conductive layer of 35 μm. A portable Field Fox vector network analyzer (VNA) N9918A measured the scattering parameter (S21) of the sensor. The measurement was automatically periodically performed using LabVIEW software. The substrate and thermocouple were positioned on a Peltier device for thermoelectric cooling and a thermocouple probe thermometer on the sensor device to monitor the temperature change of the sensor during frost formation and the water-to-ice phase transition.

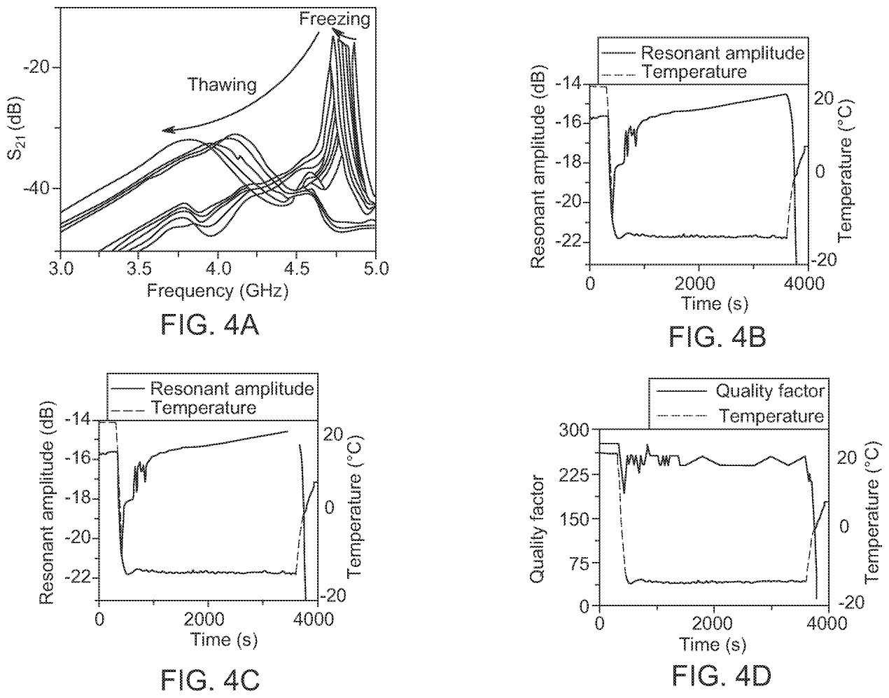

FIG. 4A shows a comparison of the measured resonance profiles of the microwave resonator 10 during freezing and thawing operations over time. FIG. 4B is a graph of resonance amplitude and temperature plotted against time during the freezing operation. FIG. 4C is a graph of resonance frequency and temperature plotted against time during the freezing operation. FIG. 4D is a graph of quality factor and temperature plotted against time during the freezing operation.

The results in FIGS. 4A through 4D demonstrate clear trends between the stage temperature and the S21 response of the resonator. As the temperature dipped below 0° C. and frost began to form, a change in resonant frequency, resonant amplitude, and quality factor was detected. These changes signified a variation of the local permittivity around the resonator due to the formation of frost. As the cooling process began, and prior to frost formation, a sharp decrease in the three parameters was measured due to the high permittivity of water that initially condensed on the resonator, which slowed as the water began to freeze. The different response rates show that the sensor was able to differentiate between water condensation and frost formation.

The resonator detected frost almost immediately (within 15 s) after the stage temperature reached 0° C., which was much sooner than when the frost became visible on the resonator with the naked eye (⁻2 min at −10° C.). As illustrated in FIG. 4A, the increase in frost thickness on the surface of the resonator was detected by continuous but slower variation in the resonant profile, which decreased from 4.85 GHz to 4.73 GHz and −21.0 dB to −14.4 during one hour of cooling. Halting the cooling after one hour and allowing the system to warm up caused a large change in the resonator response because of the melted water's large permittivity (ε water=80) relative to both the baseline (ε air=1) and the ice (ε ice=3.2).

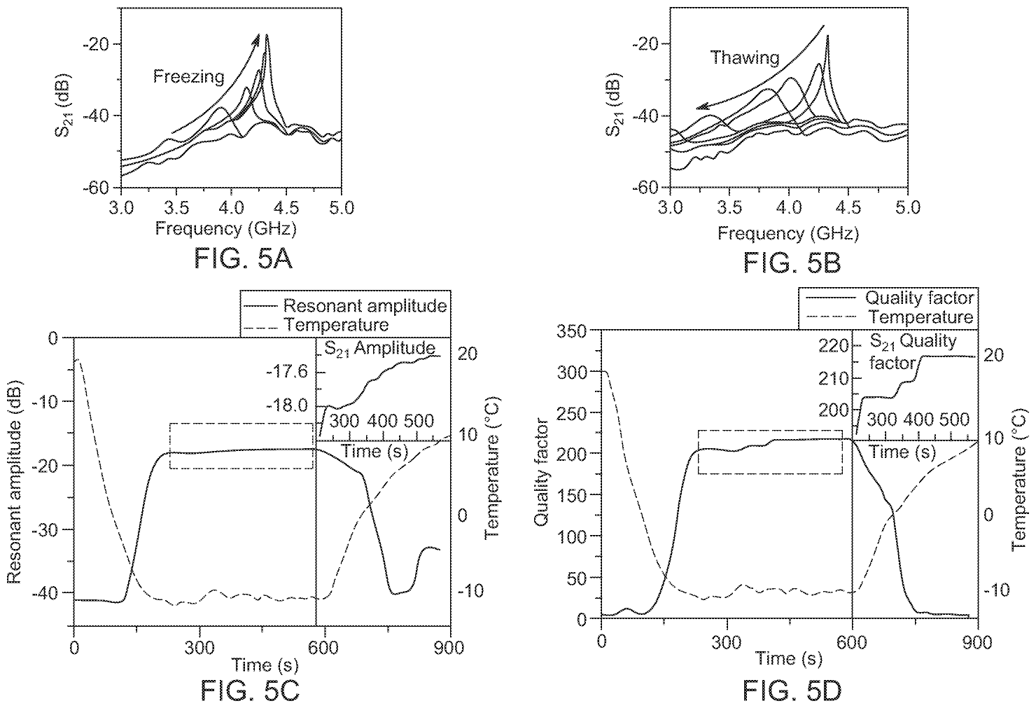

During a subsequent test, a droplet of water was placed on the center of the microwave resonator 10 of FIG. 2. Using the same cooling method, the droplet was frozen over a period of 10 minutes while the resonant profile and temperature were recorded. The experimental data for both the droplet and frost generation test are illustrated in FIG. 5A for the freezing sequence and in FIG. 5B for the thawing sequence. FIGS. 5C and 5D illustrate the resonant amplitude and quality factor over time for this freezing sequence.

When water is already present on or around the resonator, a faster and more pronounced response in all three components of the resonant profile was observed during the freezing sequence because the water/frost does not need to condense from the air, bypassing a major rate-determining step. The −3 dB quality factor and resonant amplitude showed substantially faster responses with higher variation (200 and 24 dB, respectively), which when fit to an exponential decay had time constants of 22 and 21 s, respectively. This showed that water freezing on the resonator was detected faster and with higher sensitivity than frost. In terms of sensitivity and resolution analysis, when comparing the baseline standard error to the variation measured over 15 s in the resonator due to water condensation (2.8 dB, 80 MHz, 19), droplet solidification (5.4 dB, 220 MHz, 23), and frost formation (2.0 dB, 40 MHz, 48) it is clear that the measured variation is a factor of 100-4800 higher than the standard error.

After freezing, the resonant amplitude and quality factor did not completely plateau but rather increased over 5 min from −18 to −17.4 dB and from 200 to 220, respectively. This slight increase was due to frost formation on the surface of the frozen droplet being detected by the resonator. Over time, this process plateaued because the thickening frost grew away from the resonator and the cold stage, resulting in slower frost growth as well as a reduction in resonator variation due to distance. The situation represented by this droplet test may be more common to some applications where water impacts or aggregates on a surface (aircraft, wind turbine, road) and then freezes in sub-zero conditions. In order to isolate the effects of temperature and frost generation on the resonant profile, the resonator was protected from the environment with tape while the stage-resonator system was cooled to −10° C., as in prior experiments.

### Experiment 2

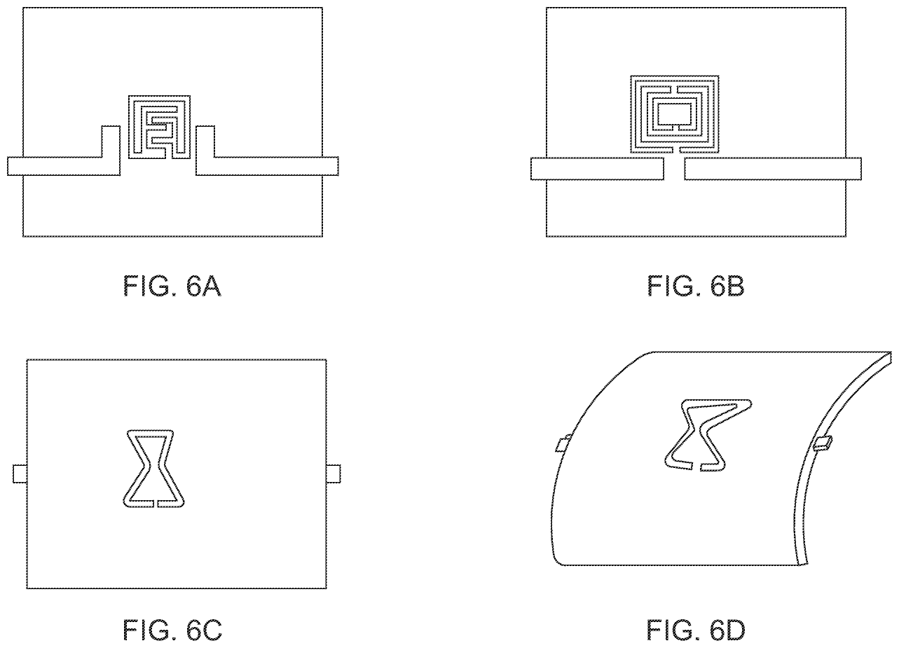

A second experiment involved providing for exemplary designs of microwave resonators. As illustrated in FIGS. 6A, 6B and 6C, the exemplary designs comprised an interdigitated sensor, a triple square resonator and a sigma resonator, respectively. Furthermore, as illustrated in FIGS. 6C and 6D, the microwave resonator may be formed as a dual resonator design in which a first resonator (as is visible on the top of the substrates of each of FIGS. 6C an 6D) and a second resonator or feedback loop located below the top or first resonator. The first and second resonators may be coupled electrically, magnetically or electromagnetically to each other as is known and may be located on separate layers of the substrate from each other and may furthermore be separated from each other by an intermediate substrate layer. It is known that the feed lines for microwave resonators are frequently one of the most sensitive regions of the microwave resonator. Such a design therefore permits the feed lines as set out above for such a coupled resonator design to be located below such intermediate substrate permitting only the region of the top microwave resonator to define the measured location.

Each of the resonators in FIGS. 6A through 6C were fabricated on a high-frequency RT/duroid 5880 substrate from Rogers as set out above. In addition, the microwave resonator of FIG. 6C was also formed on a flexible substrate as illustrated in FIG. 6D. The S21 parameters for each of the resonators was then measured during freezing and thawing as set out above.

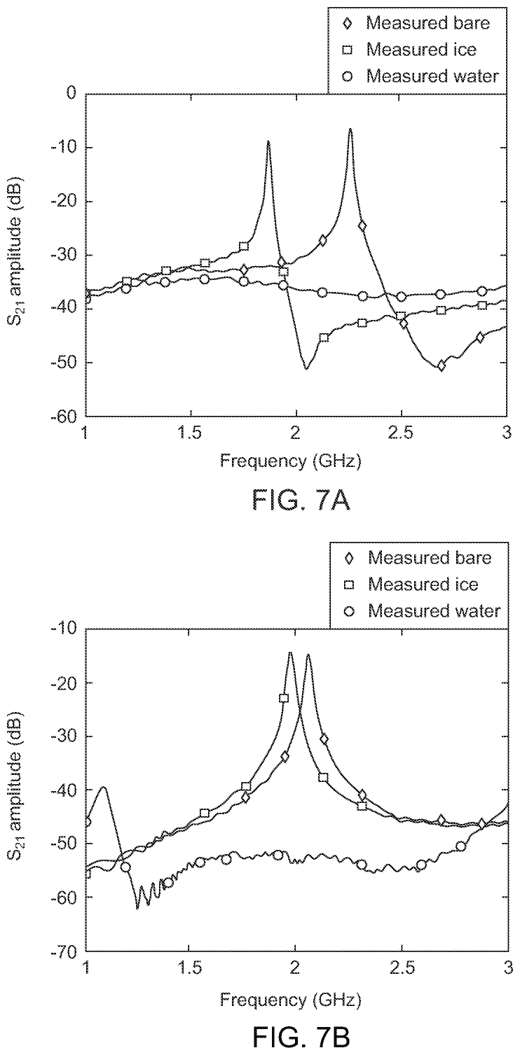

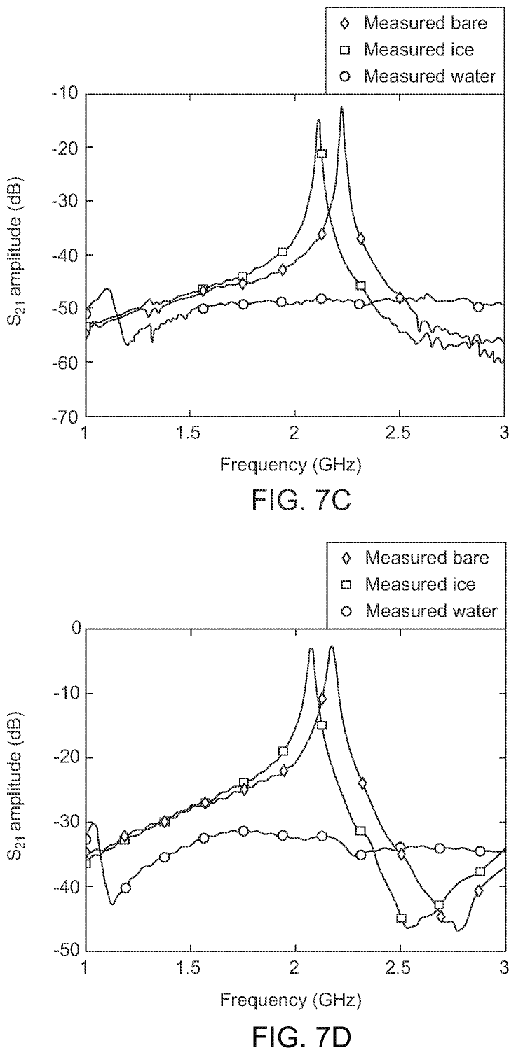

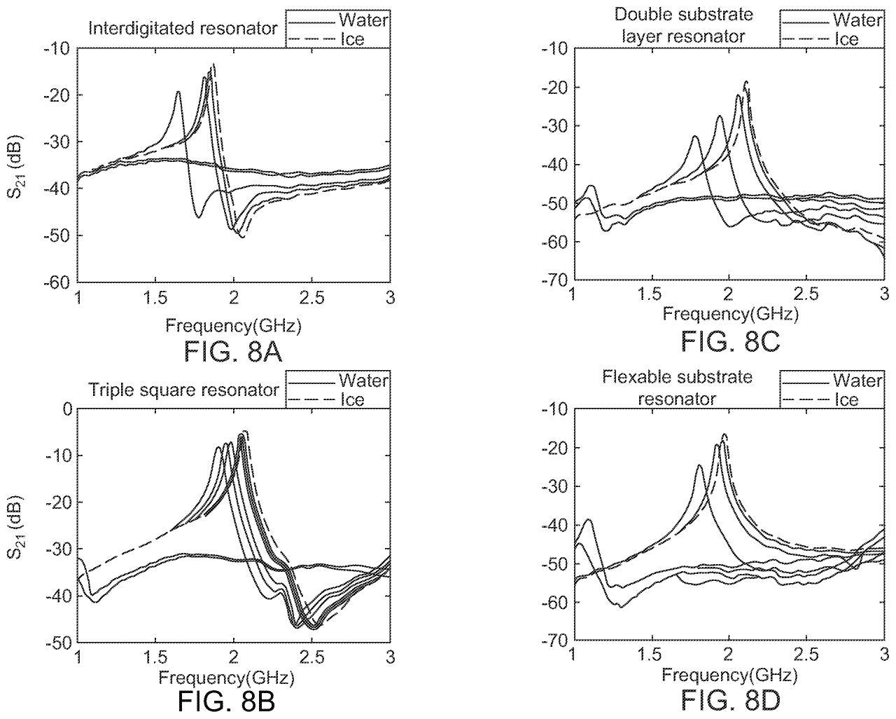

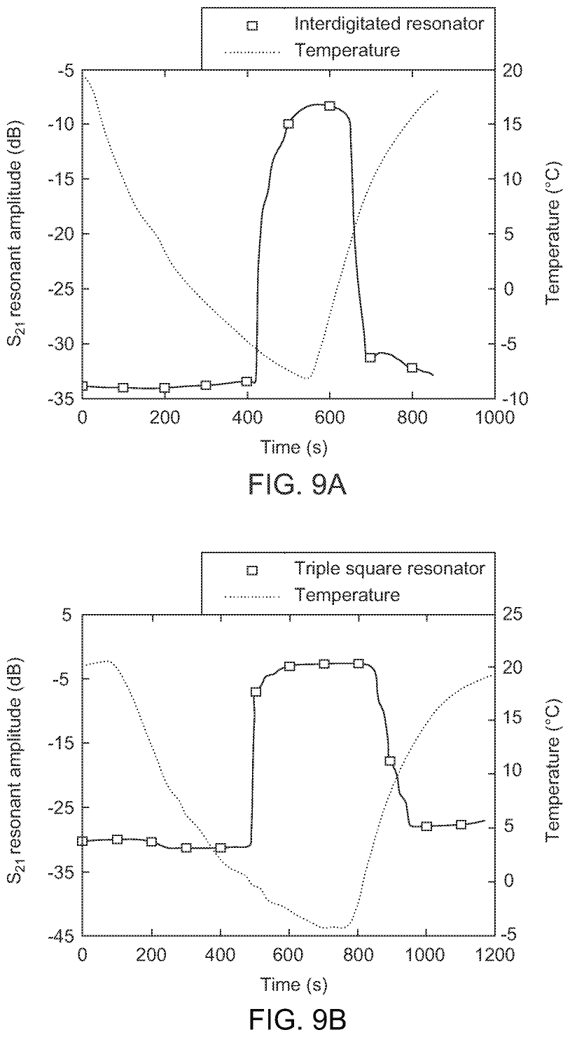

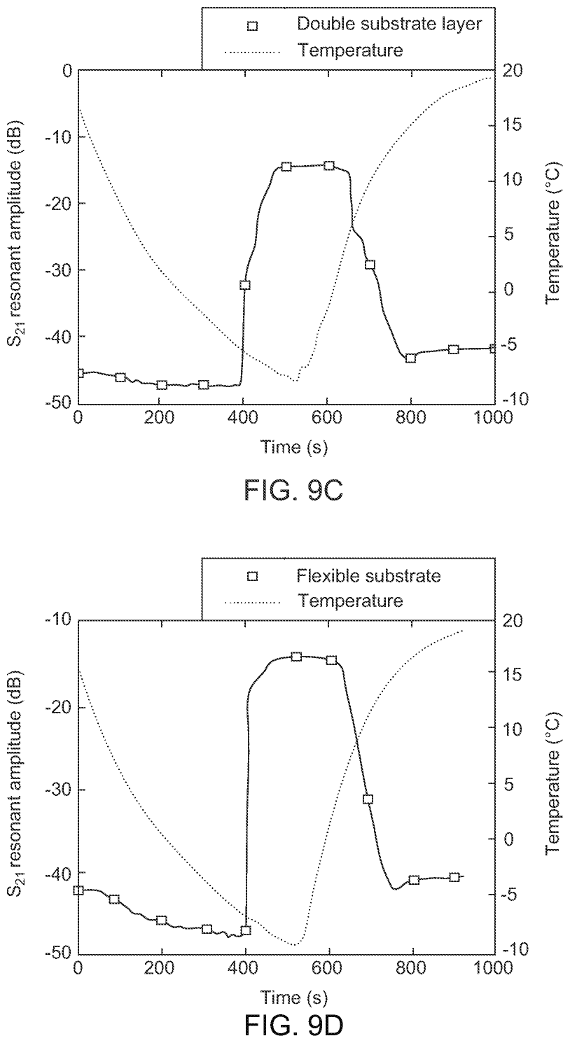

FIGS. 7A through 7D illustrate the measured S21 resonance profile for the microwave resonators from FIGS. 6A through 6D, respectively for the condition in which the resonators are bare, and water and ice is located in the measurement region. FIGS. 8A through 8D illustrate the resonance amplitude and temperature versus time for the freezing process of each of the microwave resonators from FIG. 6a through 6D, respectively.

It will be observed that the use of two layers of substrate in the flexible FIG. 6C) and double Rogers Druid 5880 (FIG. 6D) cases is that the transmission line are protected from the development of condensation and frost, making them even more robust and sensitive to a specific region compared to the traditional sensors that have the transmission lines on the same plane and the resonator. Another noticeable difference is that the triple square resonator (FIG. 6A) reacts very strongly to the initial formation of ice. As soon as a small layer of ice had formed on this resonator, the signal returned to almost full strength compared to the other three resonators, which is likely due to the structure having a much stronger magnetic coupling between the rings where the droplet was placed. It was therefore more sensitive to the change in conductivity as the initial layer of ice formed and had reduced sensitivity to the changes in permittivity. This would cause the sensor to be less sensitive to different thicknesses of ice.

### Example 3

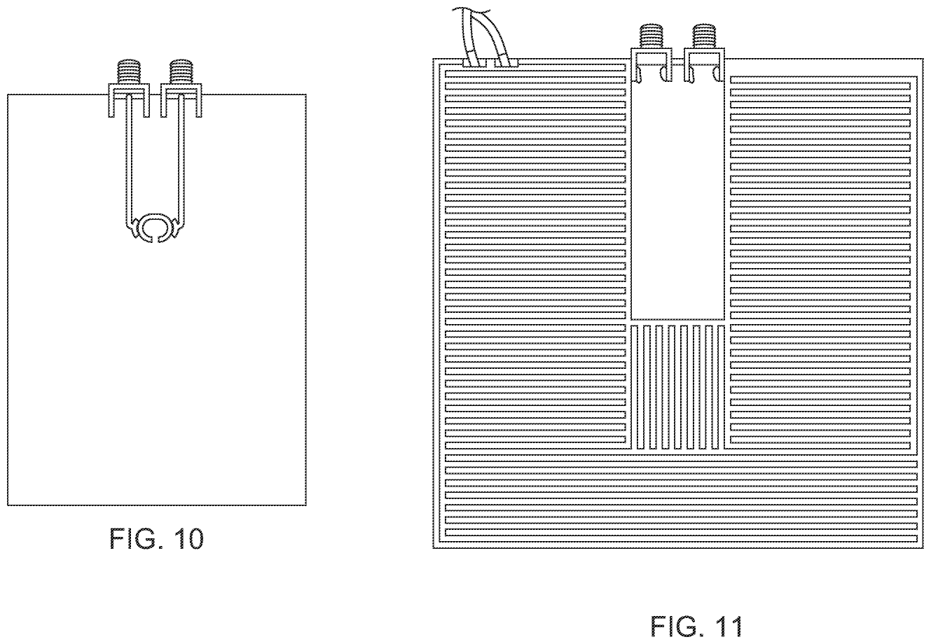

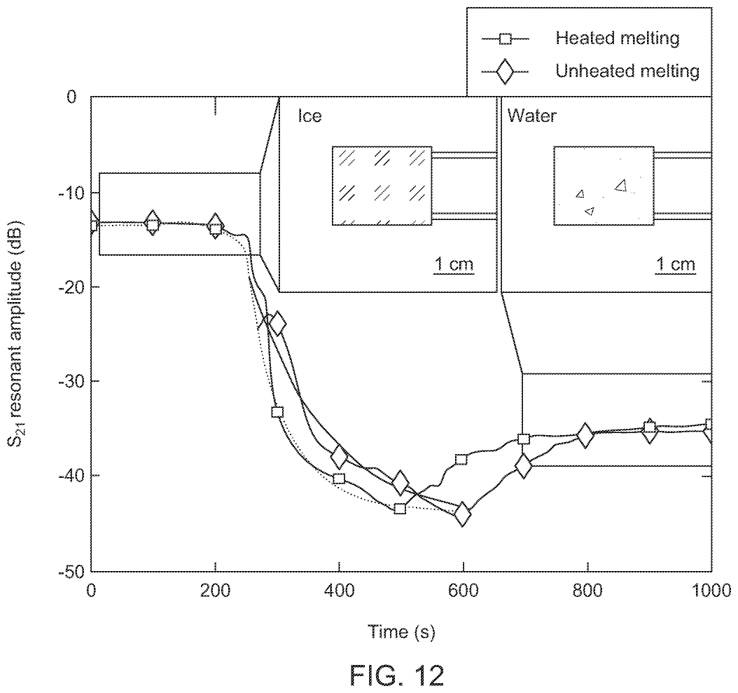

A third experiment involved providing a further exemplary design comprising a ring type microwave resonator as illustrated in FIG. 10 on a front or first surface of a substrate. A heating element was located on a rea or second surface of the substrate as illustrated in FIG. 11 and the microwave resonator of FIG. 10 subjected to both heated and unheated melting of a droplet of water. FIG. 12 illustrated measured the resonant amplitude versus time for both the heated and unheated process. As illustrated in FIG. 12, the thawing process was in fact sped up for the heated process. From these results, it is also observed that the sensor is successful in detecting exactly when the thawing began and exactly when all the ice had successfully been converted back to water. It will therefore be appreciated that the sensor of the present disclosure will also be useful in characterizing the effectiveness of dicing methods for the surface. Furthermore, the sensors of the present disclosure could be used to more accurately determine which deicing methods are more effective and provide efficiency calculations for the different methods currently in use.

### Example 4

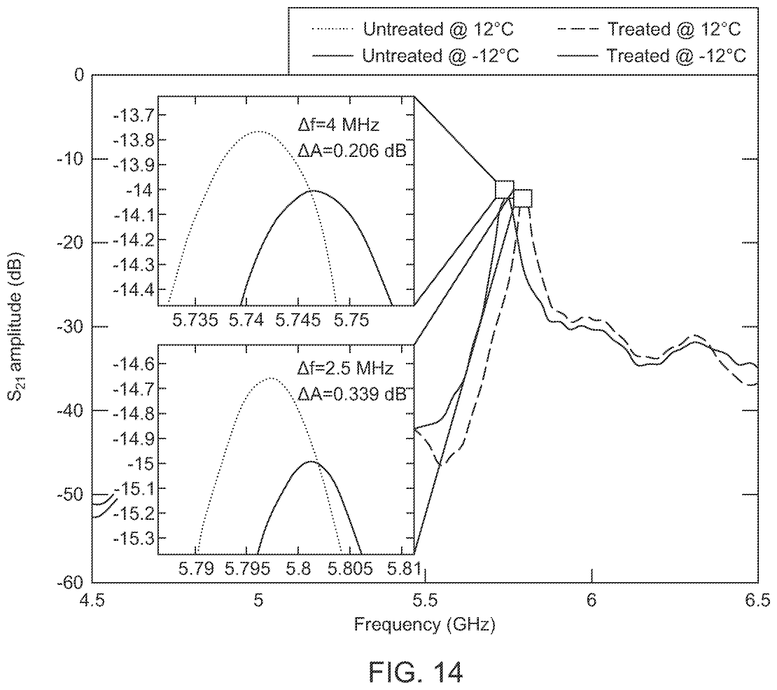

A fourth experiment involved providing a superhydrophobic coating over the microwave resonator to determine its effect on the operation of the microwave resonator. In this experiment, the superhydrophobic coating was selected to be Neverwet® by Rust-Oleum although it will be appreciated that other superhyrophobic materials and coatings may also be utilized. In particular, the hydrophobic coating was applied to an approximate thickness of was 6.3±1.1 μm. FIG. 14 illustrates that the superhydrophobic coating had a negligible effect on the S21 profile of the microwave resonator.

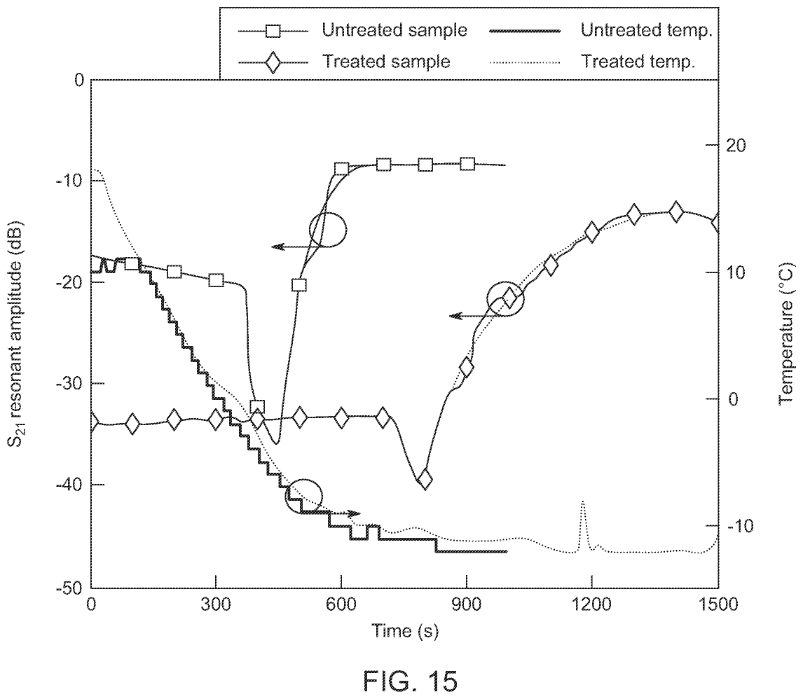

The treated and untreated (coated and uncoated, respectively) were then cooled with a droplet of water thereon. The 10 μL droplet of water measured to have to have a static contact angle of 158°±1° with an interfacial contact area of 1.5 mm² for the treated resonator and static contact angle of 107°±1° with an interfacial contact area of 9.5 mm² for the untreated resonator as illustrated in FIGS. 17A and 17B according to known wettability calculation and measurement methods. As illustrated in FIG. 15, both the treated and untreated microwave resonators were capable of detecting the formation of water. However, the superhydrophobic coating also delayed and slowed the freezing of ice on the surface of the resonator due to the decreased thermal transport through to the Peltier stage.

The sensor was able to determine when the droplet started to freeze and when it had completely frozen, for both the untreated and treated resonators.

TABLE I
TRANSIENT DATA OF DROPLET FREEZING - EXTRACTED
FROM FIG. 5

| | UNTREATED | Superhydrophobic |
|---|---|---|
| | RESONATOR | Resonator |
| Freezing Started | 360 ± 10 seconds | 720 ± 10 seconds |
| (Time and | @ −3° C. | @ −10° C. |
| Temperature) | | |
| Freezing | 610 ± 10 seconds | 1350 ± 10 seconds |
| Finished | @ −12 ° C. | @ −12° C. |
| (Time and | | |
| Temperature) | | |
| Time Constant of | 67.5 seconds | 202 seconds |
| Freezing Curve | | |

As the droplet began to freeze, the amplitude on the untreated sensor decreased due to water condensation on the transmission lines, then increased due to the freezing process until the droplet was completely ice, at which point the amplitude stabilized. The data extracted from FIG. 15 is displayed in Table I. By recording the time required for the droplet to completely freeze after the temperature passed 0° C., an effective holdover time was determined. The untreated and treated resonators required 310 and 1,040 seconds to completely freeze, respectively, after reaching 0° C. Furthermore, the superhydrophobic treatment delayed the onset of freezing by 250 seconds. The rate of freezing was also investigated by curve fitting the freezing portion of the graph to an exponential response and extracting time constants. The time constants for the untreated and treated resonators were 67.5 and 202 seconds, respectively. These time constants indicate that the freezing rate of the droplet on the superhydrophobic surface was 3 times slower than for the untreated surface.

The freezing rate decreased on the superhydrophobic surface due to the decrease in thermal conduction between the droplet and the resonator. This conductivity was estimated by calculating the heat transfers through the treated and untreated samples. In particular, the thermal resistance of the untreated RT/duroid 5880 was calculated to be R=416 K/W whereas the thermal resistance of the treated microwave resonator as set out above was calculated to be R=2,900 K/W. The main cause for this increase was the contact area of the droplet which was a direct result of the varying static contact angle. Consequently, the resultant heat transfer was decreased from 29 mW for the untreated surface to 4.4 mW for the superhydrophobic surface (an 85% reduction), assuming the SRR was at −12° C. and the water was at 0° C. The water droplet shape was assumed to be a perfectly spherical cap and perfect heat transfer was assumed at the interface of the RT/duroid 5880 substrate and the superhydrophobic coating.

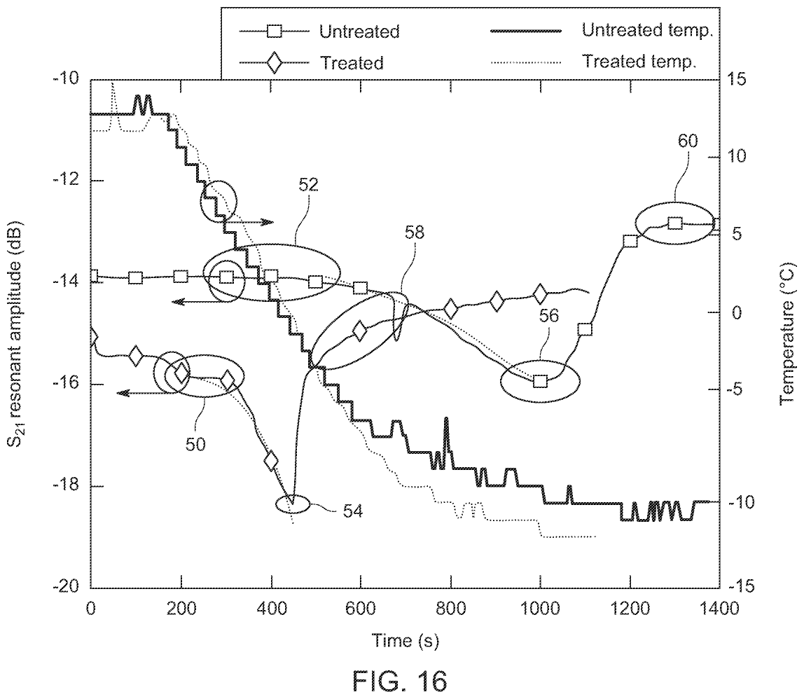

In order to determine if ice would be distinguishable between the air with the coating present, a frost formation test was also conducted. FIG. 16 displays the resonant amplitude plot over time for the frost experiment.

From these results, a clear distinction between the bare resonator and the frost-covered resonator can be made. The numbers on this plot have been added to further help explain the process. In areas 50 and 52, condensation first starts to form on the resonator. At the points 54 and 56, this condensate begins to freeze. And finally, at points 58 and 60, the condensation that accumulated has fully frozen and more frost continues to accumulate. Again, the superhydrophobic coating delayed the formation of condensation and frost due to the decreased energy transfer that occurred through the coating.

While specific embodiments have been described and illustrated, such embodiments should be considered illustrative only and not as limiting the disclosure as construed in accordance with the accompanying claims.

What is claimed is:

1. A system for detecting formation of solid-state water on a surface of a body comprising:
at least one microwave resonator sensor locatable on the body under the surface; and
an analyzer operably coupled to the at least one passive microwave resonator; the analyzer configured to measure at least one parameter of the response of the at least one microwave resonator sensor,
wherein the at least one parameter varies in relation to at least one of the permittivity and conductivity of the region above the surface calibrated to output a signal indicating,
and wherein the analyzer is configured to output an indication when the at least one parameter indicates that solid-state water has formed on the surface.

2. The system of claim 1 wherein the at least one microwave resonator sensor comprises a plurality of microwave resonator sensors.

3. The system of claim 2 wherein the plurality of microwave resonator sensors are arranged in an array on the surface of the body.

4. The system of claim 1 wherein the at least one microwave resonator sensor is formed on a substrate.

5. The system of claim 1 wherein the substrate is flexible.

6. The system of claim 1 wherein the at least on parameter is selected from the group consisting of resonant frequency, resonant amplitude and quality factor.

7. The system of claim 1 wherein a change in the at least one parameter indicates the formation of solid-state water on the surface.

8. The system of claim 1 further comprising a layer of a cover material applied over the at least one microwave resonator sensor.

9. The system of claim 8 wherein the cover material is selected to have a known permittivity.

10. The system of claim 8 wherein the cover material is applied over the surface of the body.

11. The system of claim 10 wherein the cover material is superhydrophobic.

12. The system of claim 8 wherein the cover material comprises paint.

13. The system of claim 1 further comprising a heating element activated in response to analyzer indicating the formation of solid-state water on the surface.

14. The system of claim 1 wherein the heating element is located under the at least one microwave resonator sensor.

15. A method for sensing formation of solid-state water on a surface of a body comprising:
positioning a passive microwave resonator sensor on the body under the surface;
measuring, in real time, at least one parameter of the response of the passive microwave resonator sensor at an analyzer operably connected to the passive microwave resonator sensor; and
outputting a signal indicating the formation of solid-state water on the surface in response to a change in the at least one parameter of the response of the passive microwave resonator sensor.

16. The method of claim 15 wherein the at least on parameter is selected from the group consisting of resonant frequency, resonant amplitude and quality factor.

17. The method of claim 15 wherein a change in the at least one parameter indicates the formation of solid-state water on the surface.

18. The method of claim 15 further comprising activating a heating element located under the at least one microwave resonator sensor in response to the signal indicating the formation of solid-state water on the surface.

19. The method of claim 15 wherein the at least one microwave resonator sensor comprises a plurality of microwave resonator sensors.

20. The method of claim 19 wherein the plurality of microwave resonator sensors are arranged in an array on the surface of the body.

21. The method of claim 15 wherein the at least one microwave resonator sensor is formed on a substrate.

22. The method of claim 15 wherein the substrate is flexible.

23. A method for monitoring the state of mater above a surface comprising;
positioning a passive microwave resonator sensor on a body under the surface thereof;
measuring, in real time, at least one parameter of the response of the passive microwave resonator sensor at an analyzer operably connected to the passive microwave resonator sensor; and
determining, utilizing the analyzer when a change in at least one of the permittivity and conductivity of the region above the surface, based on the at least one parameter has occurred indicating a change in state of region above the surface.

24. The method of claim 23 wherein the at least on parameter is selected from the group consisting of resonant frequency, resonant amplitude and quality factor.

25. The method of claim 23 wherein the analyzer is calibrated to at least one of the permittivity of and conductivity water in ach of gas, liquid and solid states.

26. The method of claim 23 wherein the analyzer is configured to output a signal indicating the formation of a solid-state water above the surface t

27. The method of claim 24 further comprising determining, utilizing the analyzer, if the state of the material above the surface has changed from a liquid to a solid indicating the formation of ice on the surface or if the state of the material above the surface has changed from a gas to a solid indicating the formation of frost on the surface.
